(19) United States
(12) Patent Application Publication
(10) Pub. No.: US 2009/0002338 A1
(43) Pub. Date: Jan. 1, 2009

(54) Screen input type image display

(76) Inventors: Masayoshi Kinoshita, Oita (JP); Norio Mamba, Kawasaki (JP)

Correspondence Address: REED SMITH LLP, Suite 1400, 3110 Fairview Park Drive, Falls Church, VA, 22042, US

(21) Appl. No.: 12/155,209

(22) Filed: May 30, 2008

(30) Foreign Application Priority Data
Jun. 27, 2007 (JP) 2007-169031

(51) Int. Cl. G06F 3/045

(52) U.S. Cl. 345/174

(57) ABSTRACT

In an image display device incorporating a touch sensor capable of detecting coordinates with simple structure and high precision, a transparent conductive film on a substrate SUB forming a display screen of the image display device is patterned to form detection electrodes taking the shape of a plurality of pad electrodes SSP arranged in a two-dimensional matrix form of rows (X direction) and columns (Y direction). Row connection electrodes LNL and column connection electrodes LNC connecting the detection electrodes in rows and columns of the two-dimensional matrix to each other are formed of the same transparent conductive film as the pad electrodes. By arranging the pad electrodes in the matrix form, the contact area of a finger or the like touching the screen can be made large, resulting in improved detection precision (resolution). The pad electrodes are connected at four corners to coordinate detection terminals PDT1 to PDT4.

### INCORPORATION BY REFERENCE

The present application claims priority from Japanese application JP2007-169031 filed on Jun. 27, 2007, the content of which is hereby incorporated by reference into this application.

### BACKGROUND OF THE INVENTION

The present invention relates to a screen input type image display, or display device. In particular, the present invention is suitable for raising the coordinate detection precision in an image display device having a touch sensor of capacitive coupling scheme.

Image display devices including touch sensors having a screen input function of inputting information by touch operation (hereafter referred to simply as touch) of a user's finger or the like with a display screen are used in mobile electronic devices such as PDAs and potable terminals, various home electronic products, and stationary customer guide terminals such as unattended reception devices. As image display devices having such a touch input function, a scheme of detecting a resistance value change or a capacitance value change in a touched part and a scheme of detecting a light quantity change in a part shielded by touch are known.

As the scheme of detecting s resistance value change which is widely adopted at the present time, there is a two-layer film type obtained by sticking two resistor films together with a minute space to form a sheet and stacking the sheet on a screen part of a liquid crystal display device. In such a scheme, the two resistor films having an air layer between are laminated on the screen and consequently the transmittance of display light supplied from the image display device is lowered. In addition, since two-layer film type is commercialized as a touch panel, the touch panel itself has a thickness and a weight. When the two-layer film type is combined with an image display device, therefore, the thickness and weight of the whole are increased.

On the other hand, there is a scheme of detecting touch coordinates by using one sheet of resistor film and detecting a resistance change. In this scheme, a transparent conductive film for position detection is provided, for example, on the opposite side of a liquid crystal panel included in a liquid crystal display device from a glass substrate having a counter electrode (Patent Document 1). In this single film scheme, coordinates of a touched part are detected by applying an alternating voltage to the transparent conductive film and detecting a current flowing through a finger which has touched the transparent conductive film. This scheme utilizes a fact that the current flowing through the finger which has touched is changed according to a resistance value between the touch part and a point at which the alternating current is applied.

A capacitance detection sensor including a substrate on which electrodes formed of the transparent conductive films are arranged on one surface, and including electrodes of the transparent conductive films disposed so as to prescribe an arrangement of detection cells disposed in columns and rows to form a detection area of a touched part is described in Patent Document 2.

FIG. 17A is a plan view for explaining an example of a conventional touch sensor. In this touch sensor, a transparent conductive film 7 is formed all over a face of a substrate 9 which forms a display face of an image display device. Coordinate detection terminals A, B, C and D are provided on four corners of the transparent conductive film 7.

FIG. 17B is a diagram for explaining an operation principle of a touch sensor of the conventional single film scheme. As shown in FIG. 17A, a transparent conductive film 7 such as the ITO is stuck to a one face of a substrate which forms a screen of an image display device. Alternating current sources of the same phase and potential are connected through current detection resistors connected to the coordinate detection terminals A, B, C and D (see FIG. 17A) provided on four corners of the transparent conductive film 7. If a finger or the like touches the transparent conductive film 7, currents i1, i2, i3 and i4 which flow through the current detection resistors at this time change. The currents i1, i2, i3 and i4 are current values detected between a touched place and the coordinate detection terminals A, B, C and D. The current values depend upon resistance values between the touched place and the coordinate detection terminals A, B, C and D. Coordinates of the touch position are calculated on the basis of ratios among them. By the way, Z is an impedance between the finger or the like and ground.

FIG. 18 is a configuration diagram for explaining another example of a touch sensor according to the conventional single film scheme. This touch sensor is a two-dimensional capacitance type sensor. This sensor includes five-row by three-column detection cells. In detection cells in a column (for example, the detection cell 84), the column detection electrodes pass through detection cells continuously as a spine and the row detection electrodes are formed of two conductive areas located on both sides of the column detection electrodes.

In detection cells in columns located at ends of a detection area (i.e., for example, a detection cell 86 in columns x1 and x3), row detection electrodes pass through detection cells continuously and column detection electrodes are formed of two conductive areas located on both sides of row detection electrodes. In this configuration, a column detection electrode and a row detection electrode of each detection cell are connected electrically to each other. Since row detection electrodes of detection cells located at both ends are connected to each other by an electric wire formed outside the detection area, the electric wire does not need to cross the inside of the detection area. In other words, it is possible to provide a capacitance type position sensor including a detection area which has electrodes only on one side of the substrate.

Patent Document 1: JP-A-2003-66417

Patent Document 2: JP-A-2007-18515

A display device with touch sensor disclosed in Patent Document 1 calculates coordinates by providing detection resistors on four corners of a rectangular transparent conductive film and detecting currents which flow through the detection resistors. As compared with a peripheral part, therefore, the coordinate calculation precision of a central part falls. Furthermore, a two-dimensional position sensor disclosed in Patent Document 2 has a configuration in which electric wires for connecting detection electrodes in a plurality of columns and rows cross each other outside the detection area. Therefore, it is necessary to provide two wiring layers. As a result, the structure becomes complicated and the number of manufacturing processes becomes more than that in a simple structure described in Patent Document 1.

### SUMMARY OF THE INVENTION

An object of the present invention is to provide an image display device incorporating a touch sensor capable of detecting coordinates with a simple structure and high precision.

A screen input type image display device according to the present invention includes a transparent conductive film such as ITO formed as a film on a substrate which forms a display screen. The transparent conductive film on the substrate which forms the display screen of the image display device is patterned to form detection electrodes taking the shape of a plurality of pad electrodes arranged in a two-dimensional matrix form of rows (X direction) and columns (Y direction). Row connection electrodes and column connection electrodes for connecting the detection electrodes taking the shape of pad electrodes arranged in rows and columns of the two-dimensional matrix to each other are formed of the same transparent conductive film as the pad electrodes. Since the detection electrodes are formed as the matrix arrangement of pad electrodes, the contact area of the finger or the like which touches the screen is made large and the detection precision (resolution) is improved. The detection electrodes formed of a transparent conductive film are connected to coordinate detection terminals by row connection electrodes and column connection electrodes at four corners or a larger number of places.

The resistance value of the transparent conductive film increases as the location advances from the peripheral part of the matrix to the center part. As means for compensating the resistance increase, the wiring widths of the row connection electrodes and the column connection electrodes are increased (widened) as the location approaches one place in the center part of the matrix or a plurality of places inside the matrix. As other means for compensating the resistance increase, it is possible to set the number of wires of the row connection electrodes and column connection electrodes equal to a plural number, use jointly an increase in the number of row connection electrodes and column connection electrodes and an expansion of widths, or increase the film thickness.

A representative configuration according to the present invention will now be described. A screen input type image display device according to the present invention includes a touch sensor to detect two-dimensional coordinates of a touch position of a finger or the like on a display screen. The touch sensor includes a plurality of pad electrodes arranged in a two-dimensional matrix form on a substrate which forms the display screen of the image display device, a transparent conductive film forming row connection electrodes and column connection electrodes to connect the pad electrodes in rows (X direction) and columns (Y direction) included in the two-dimensional matrix to each other, and coordinate detection terminals provided respectively in a plurality of places in a fringe of the transparent conductive film.

The coordinate detection terminals are connected to the transparent conductive film via wires at ends including a plurality of corners of the transparent conductive film. And two-dimensional coordinates of a touch position on the transparent conductive film (pad electrodes, row connection electrodes, and column connection electrodes) are detected on the basis of currents which flow through the coordinate detection terminals in response to touch with the pad electrodes.

An alternating current generation circuit connected to the coordinate detection terminals via detection resistors, and a signal processing circuit for generating coordinate data which represent the two-dimensional coordinates of the touch position on the basis of voltages generated across the detection resistors connected to the corners or the like by the currents are included.

Furthermore, wiring widths of the column connection electrodes and the row connection electrodes are made gradually wider as the location approaches the inside of the matrix. The column connection electrode and the row connection electrode having widest wiring widths are located in one place in a center part on the inside of the matrix, in one place in a part which is eccentric from the center part on the inside of the matrix, or in a plurality of places on the inside of the matrix.

A substrate forming the display screen of the image display device includes an indispensable structure material included in the image display device and an additional structure material stacked on the indispensable structure material, and the additional structure material includes the transparent conductive film or the indispensable structure material included in the image display device includes the transparent conductive film.

In the present invention, the resolution of the coordinate detection (detection precision of high resolution) is improved by processing the transparent conductive film and patterning pad electrodes serving as detection electrodes in the matrix arrangement and the row connection electrodes and the column connection electrodes which connect the pad electrodes to each other. Furthermore, the precision of coordinate detection near a part in the matrix is improved by lowering resistance values of connection electrodes as the location approaches the center part from four corners or a larger number of places of the matrix. According to the present invention, it is possible to provide an image display device capable of selecting a screen area and inputting a character by providing a touch sensor of high resolution.

The present invention is effective for the whole of medium and small sized displays such as liquid crystal displays and organic EL displays. However, the present invention can be applied to large-sized displays such as plasma displays and the whole touch panels.

Other objects, features and advantages of the invention will become apparent from the following description of the embodiments of the invention taken in conjunction with the accompanying drawings.

### BRIEF DESCRIPTION OF THE DRAWINGS

FIG. 1 is a plan view of a principal part of a touch sensor for explaining a first embodiment of the present invention;

FIG. 2 is a diagram for explaining a state in which a peripheral circuit is connected to the touch panel shown in FIG. 1;

FIG. 3 is a block diagram for explaining a configuration of a peripheral circuit shown in FIG. 2;

FIG. 4 is a diagram showing a display screen of an image display device to specifically explain the first embodiment of the present invention;

FIG. 5 is a plan view of a principal part for explaining a second embodiment of the present invention in the same way as FIG. 1;

FIG. 6 is a plan view of a principal part of a touch panel for explaining a third embodiment of the present invention;

FIG. 7 is a diagram for explaining a difference in touch position in a matrix and coordinate detection output value between a case where widths of row connection electrodes LNL and column connection electrodes LNC are made the same in a matrix plane and the widths of the electrodes are gradually widened from the peripheral part toward the center;

FIG. 8A is a structure diagram of a touch panel for obtaining characteristics shown in FIG. 7;

FIG. 8B is another structure diagram of a touch panel for obtaining characteristics shown in FIG. 7;

FIG. 9 is a plan view of a principal part of a touch panel for explaining a fourth embodiment of the present invention, the same reference characters as those in the foregoing diagrams denote like function parts;

FIG. 10 is an exploded oblique view for explaining a first example of an image display device having a touch panel according to the present invention mounted thereon;

FIG. 11A is an exploded oblique view for explaining a second example of an image display device having a touch panel according to the present invention mounted thereon;

FIG. 11B is an exploded oblique view for explaining a third example of an image display device having a touch panel according to the present invention mounted thereon;

FIG. 12A is an exploded oblique view for explaining a fourth example of an image display device having a touch panel according to the present invention mounted thereon;

FIG. 12B is an exploded oblique view for explaining a fifth example of an image display device having a touch panel according to the present invention mounted thereon;

FIG. 13 is a diagram for explaining an example of a processing system of image data and touch coordinate data in a screen input type image display device according to the present invention;

FIG. 14 is a front view for explaining a sixth example of an image display device having a touch panel according to the present invention mounted thereon;

FIG. 15 is a plan view of a principal part of a touch panel for explaining a fifth embodiment of the present invention;

FIG. 16 is a plan view of a principal part of a touch panel for explaining a sixth embodiment of the present invention;

FIG. 17A is a plan view for explaining an example of a conventional touch sensor;

FIG. 17B is a diagram for explaining an operation principle of a touch sensor according to a conventional single film scheme; and

FIG. 18 is a configuration diagram for explaining another example of a touch sensor according to the conventional single film scheme.

### DESCRIPTION OF THE EMBODIMENTS

Hereafter, embodiments of the present invention will be described in detail with reference to the drawings of the embodiments.

### First Embodiment

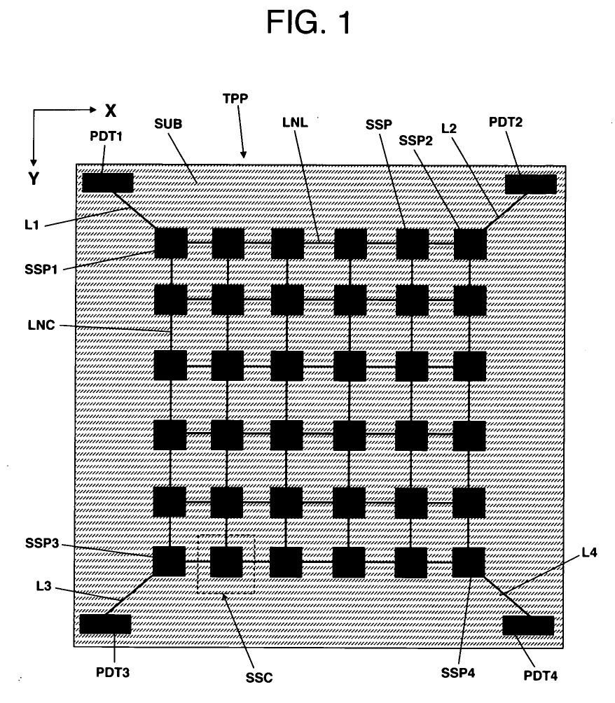

FIGS. 1 to 4 are diagrams for explaining a first embodiment of the present invention. FIG. 1 is a plan view of a principal part of a touch sensor for explaining the first embodiment of the present invention. This touch sensor includes a touch panel TPP for detecting a position of an input from the outside in an operation plane which spreads in an X direction (row direction) and a Y direction (column direction) by using a static capacitive coupling scheme. This touch sensor is a touch sensor which detects an input point from external in an operation plane (touch input plane) spreading in the X direction and the Y direction.

The touch panel TPP is formed by arranging a plurality of pad electrodes SSP obtained by patterning a transparent conductive film for which the ITO is suitable, and row connection electrodes LNL and column connection electrodes LNC which connect the pad electrodes SSP to each other, on a surface of a substrate SUB so as to form a two-dimensional matrix. One pad electrode SSP, and parts of a row connection electrode LNL and a column connection electrode LNC belonging to the pad electrode SSP constitute a detection cell SSC which is the unit of detection. All of the row connection electrode LNL and column connection electrode LNC belonging to the pad electrode SSP formed in the touch panel TPP become the same potential.

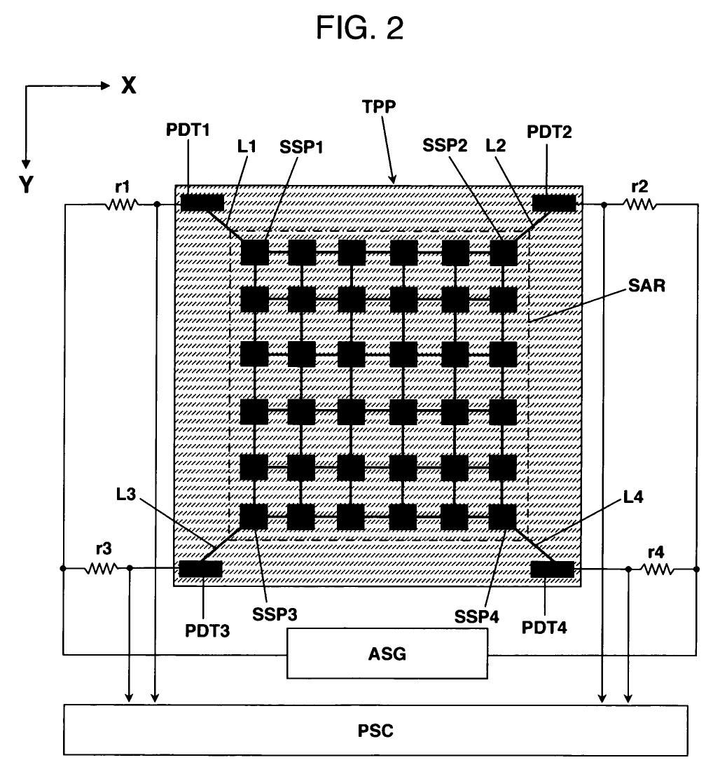

FIG. 2 is a diagram for explaining a state in which a peripheral circuit is connected to the touch panel shown in FIG. 1. On outside of a detection area SAR, pad electrodes SSP1, SSP2, SSP3 and SSP4 located on four corners of the matrix are connected to coordinate detection terminals PDT1, PDT2, PDT3 and PDT4 disposed on corners of the substrate SUB by wires L1, L2, L3 and L4, respectively. The coordinate detection terminals PDT1, PDT2, PDT3 and PDT4 and the wires L1, L2, L3 and L4 may be metal wires.

An alternating current generation circuit ASG for supplying position detection alternating voltage is connected to the coordinate detection terminals PDT1, PDT2, PDT3 and PDT4 through current detection resistors r1, r2, r3 and r4, respectively. Furthermore, a signal processing circuit PSC for calculating coordinates is connected to the coordinate detection terminals PDT1, PDT2, PDT3 and PDT4 so as to detect voltages generated across the current detection resistors r1, r2, r3 and r4, respectively.

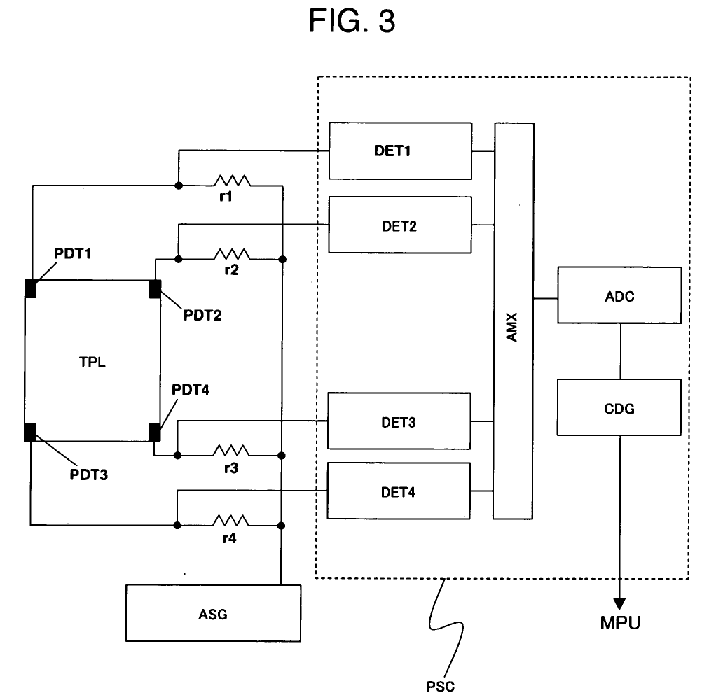

FIG. 3 is a block diagram for explaining a configuration of the peripheral circuit shown in FIG. 2. The signal processing circuit PSC includes waveform detection circuits DET1, DET2, DET3 and DET4 for detecting waveform distortion quantities caused in current waveforms input from the alternating current generation circuit ASG to the coordinate detection terminals PDT1, PDT2, PDT3 and PDT4 via the current detection resistors r1, r2, r3 and r4 by contact of a finger, an analog multiplexer AMX for coupling outputs of as many waveform detection circuits DET1, DET2, DET3 and DET4 as the coordinate detection terminals, an AD converter ADC connected via the analog multiplexer AMX, and a coordinate data generation circuit CDG for deducing coordinate data from digital data obtained by conversion conducted by the AD converter ADC.

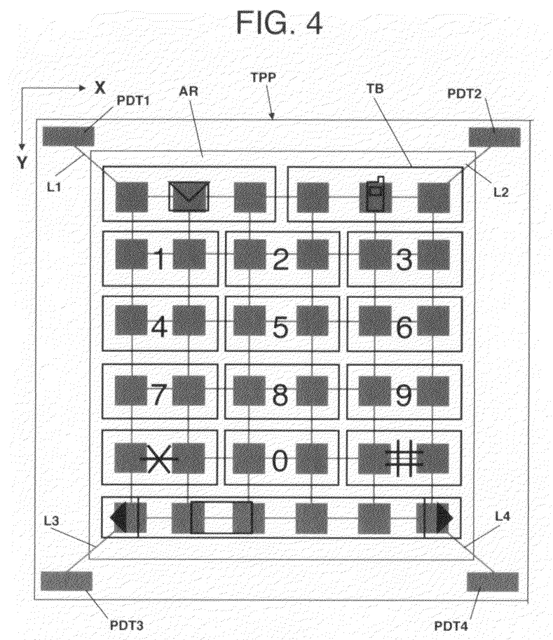

FIG. 4 is a diagram showing a display screen of an image display device to specifically explain the first embodiment of the present invention. The touch panel described above is provided on the display screen of the image display device. Touch buttons TB's are displayed in positions of the touch panel TPP corresponding to pad electrodes. In FIG. 4, touch buttons TB's are displayed supposing a display screen of a portable telephone. In other words, ten key buttons (1, 2, 3, . . . 0), a sharp button, an asterisk button, a mail selection button, a talk button, and a slider button are displayed on the screen. One or more pad electrodes are assigned to a position corresponding to each display. Owing to this configuration, data of coordinates of a position where the finger has touched a touch button are discriminated by the configuration shown in FIG. 3, and recognized as a predetermined command by the main body of the portable telephone.

### Second Embodiment

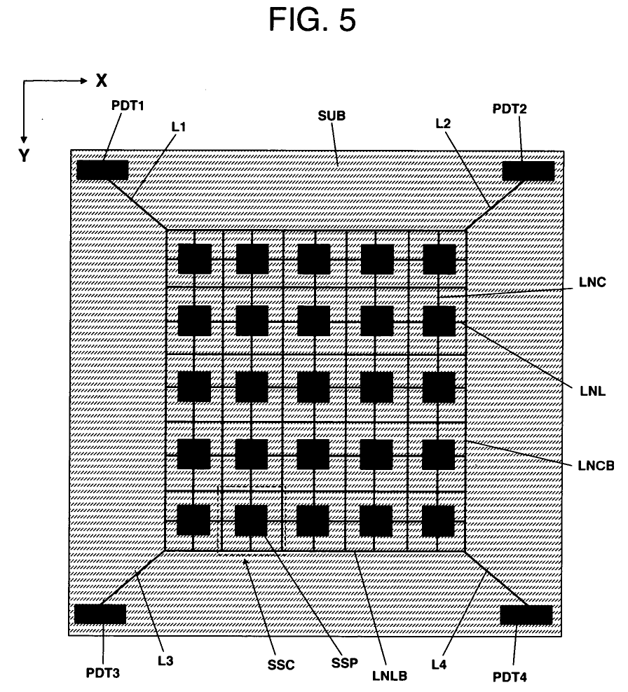

FIG. 5 is a plan view of a principal part for explaining a second embodiment of the present invention in the same way as FIG. 1. The same reference characters as those in FIG. 1 denote like functional parts, and in principle duplicate description of them will be omitted. In addition to the pad electrodes SSP, the row connection electrodes LNL and the column connection electrodes LNC in the first embodiment, row spine electrodes LNLB and column spine electrodes LNCB for mutually connecting only the row connection electrodes LNL and the column connection electrodes LNC are included in the second embodiment. And a row spine electrode LNLB and a column spine electrode LNCB on outermost sides of the matrix, and coordinate detection terminals PDT1 to PDT4 are connected by wires L1 to L4.

According to the configuration according to the second embodiment, the row spine electrodes LNLB and column spine electrodes LNCB in addition to the detection cell SSC constitute current paths. As a result, the resistance values of the matrix become low and the difference in resistance value between a central part and a peripheral part of the matrix is reduced.

### Third Embodiment

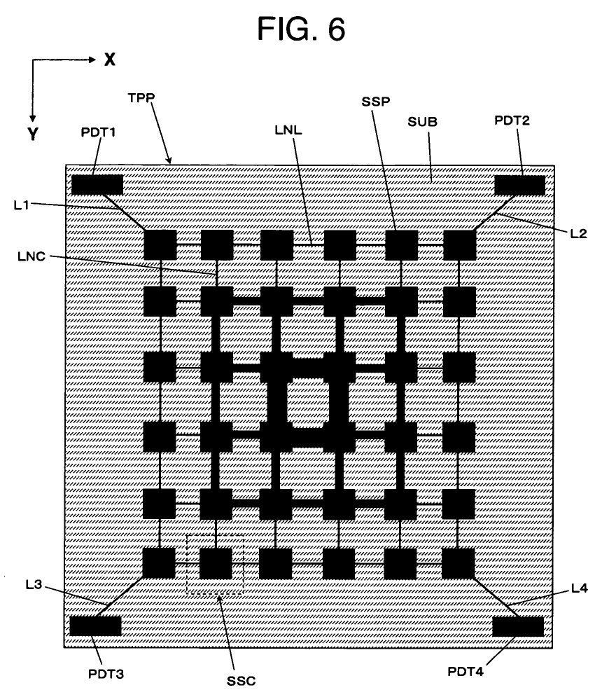

FIG. 6 is a plan view of a principal part of a touch panel for explaining a third embodiment of the present invention. The same reference characters as those in FIGS. 1 and 5 denote like functional parts, and in principle duplicate description of them will be omitted. In the third embodiment, pad electrodes located on four corners of a fringe of a detection area are electrically connected to coordinate detection terminals PDT1 to PDT4 provided on four corners of the substrate via wires L1 to L4 each formed of a transparent conductive film or a metal film. Electrode widths of the row connection electrodes LNL and the column connection electrodes LNC which connect detection cells SSC of the matrix are made wider in the center part than in the peripheral part. The electrode widths of the row connection electrodes LNL and the column connection electrodes LNC are made gradually wide from the peripheral part toward the central part so as to become the minimum in the peripheral part and maximum in the central part.

According to the configuration in the third embodiment, the difference of the in-plane resistance value of the matrix can be made small as compared with the first embodiment, and lowering of the detection precision in the central part caused by the difference in resistance value between the central part of the matrix and the peripheral part can be suppressed.

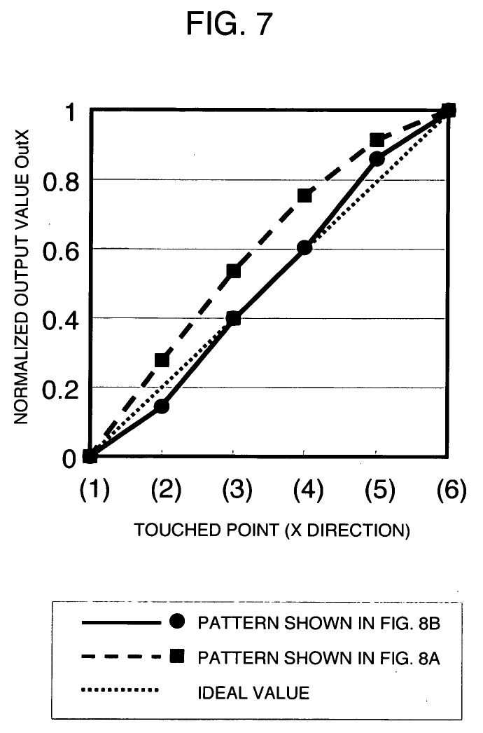

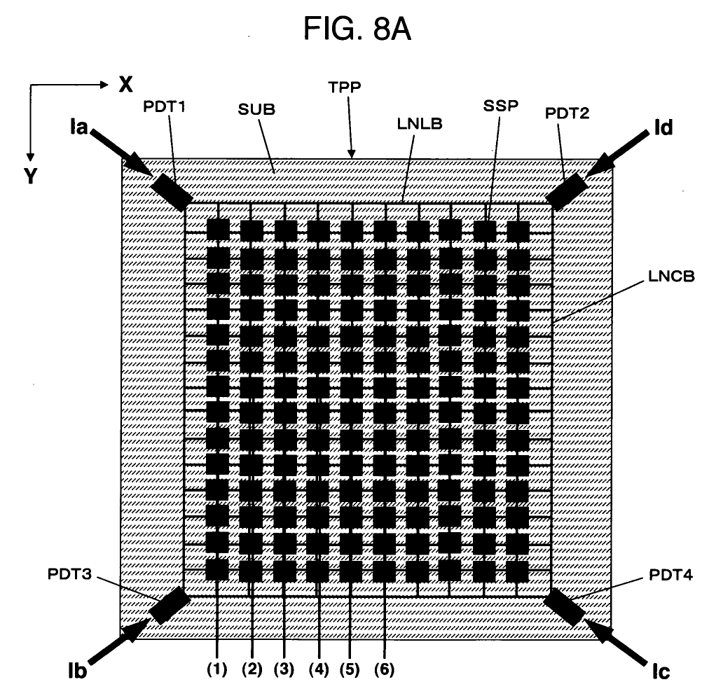

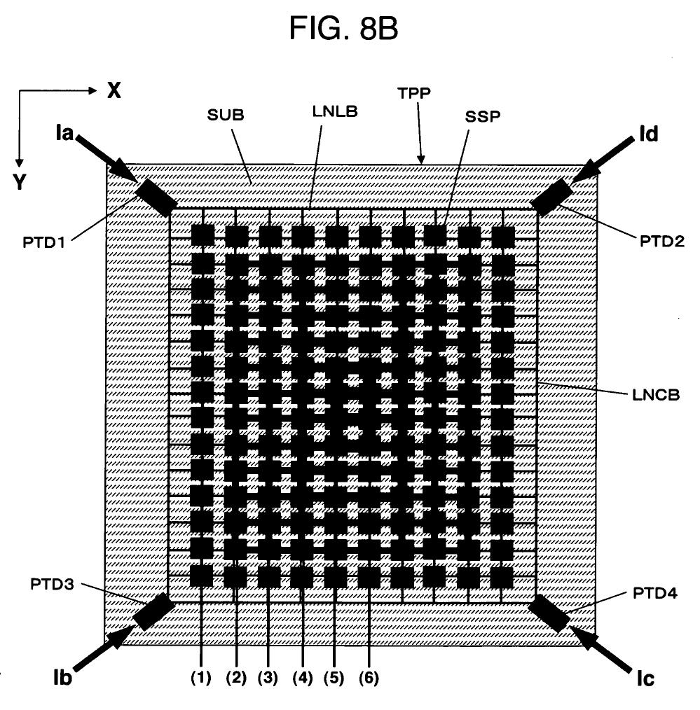

FIG. 7 is a diagram for explaining a difference in touch position in the matrix and coordinate detection output value between a case where widths of the row connection electrodes LNL and the column connection electrodes LNC are made the same in the matrix plane and a case where the widths of the electrodes are gradually widened from the peripheral part toward the center. FIGS. 8A and 8B are structure diagrams of a touch panel for obtaining characteristics shown in FIG. 7. The same reference characters as those in the foregoing diagrams denote like function parts.

In FIG. 8A, the widths of the row connection electrodes LNL and the column connection electrodes LNC are made the same in the matrix plane. In FIG. 8B, the widths of the row connection electrodes LNL and the column connection electrodes LNC are gradually widened from the peripheral part toward the center. FIG. 7 shows coordinate detection outputs (normalized current outputs) at touch points (here represented by pad electrodes) (1) to (6) in the matrix which forms the touch panel TPP for FIG. 8A and FIG. 8B. The outputs are results obtained by comparing X coordinate outputs in FIG. 8A with those in FIG. 8B by using the following expressions (1) and (2). A dotted line in FIG. 7 indicates ideal values (linear).

X coordinate:

X(i)=(Ia+Id)/(Ia+Ib+Ic+Id) (1)

X coordinate output:

OutX={X(i)−X(6)}/X(i) (2)

It is appreciated from the results shown in FIG. 7 that the detection precision is improved by forming the pattern of the row connection electrodes LNL and the column connection electrodes LNC shown in FIG. 8B.

### Fourth Embodiment

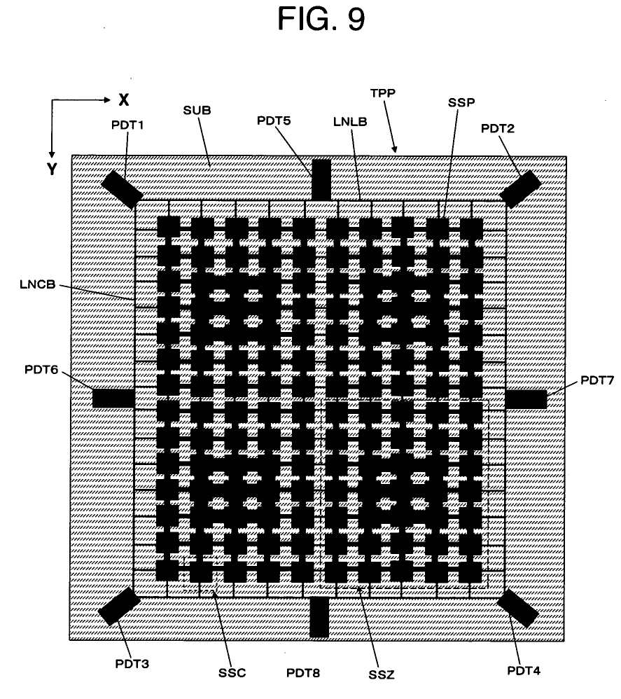

FIG. 9 is a plan view of a principal part of a touch panel for explaining a fourth embodiment of the present invention. The same reference characters as those in the foregoing diagrams denote like function parts. In the fourth embodiment, the matrix plane is divided into four parts. In the matrix divided into four parts, two-column by two-row groups of detection cells SSC are provided. In addition, besides the four connection electrodes PDT1 to PDT4 provided on four corners of the touch panel TPP, four connection electrodes PDT5 to PDT8 are provided on middle points of four sides. Widths of the row connection electrodes LNL and the column connection electrodes LNC are maximized in the center of each group, and made gradually narrower as the location approaches the center and peripheral part of the matrix.

In the fourth embodiment, the detection precision in each group of detection cells SSC in the matrix can be improved. In other words, a selected image is assigned to each group and consequently the detection precision in coordinates corresponding to each selected image can be improved.

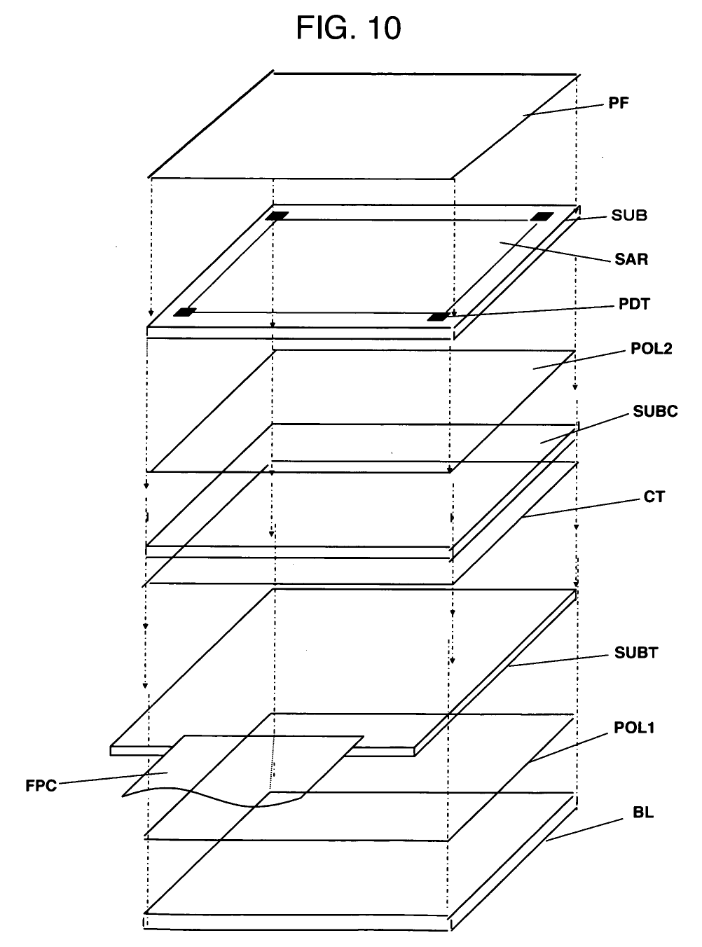

FIG. 10 is an exploded oblique view for explaining a first example of an image display device having a touch panel according to the present invention mounted thereon. This image display device is a liquid crystal display device, and it is formed by enclosing liquid crystal between an active substrate SUBT having thin film transistor circuits such as a pixel circuit and a drive circuit formed thereon and a counter substrate SUBC having a counter electrode CT. Sheet polarizers POLL and POL2 are located on outer faces of the active substrate SUBT and the counter substrate SUBC, respectively. A back light BL is disposed on the back of the active substrate SUBT. By the way, FPC is a flexible print circuit board for inputting a display signal and power supply from a signal source.

A surface of a transparent substrate SUB disposed on the POL2 on the counter substrate SUBC side has a detection area SAR of a touch panel including a transparent conductive film pattern having a configuration according to any of the embodiments. The detection area SAR of the transparent conductive film pattern is covered by a transparent protection film PF.

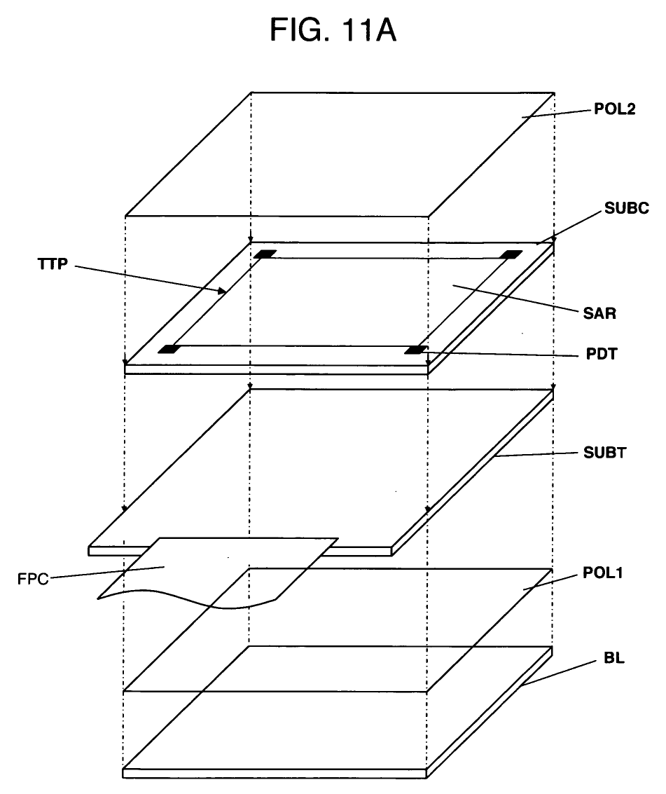

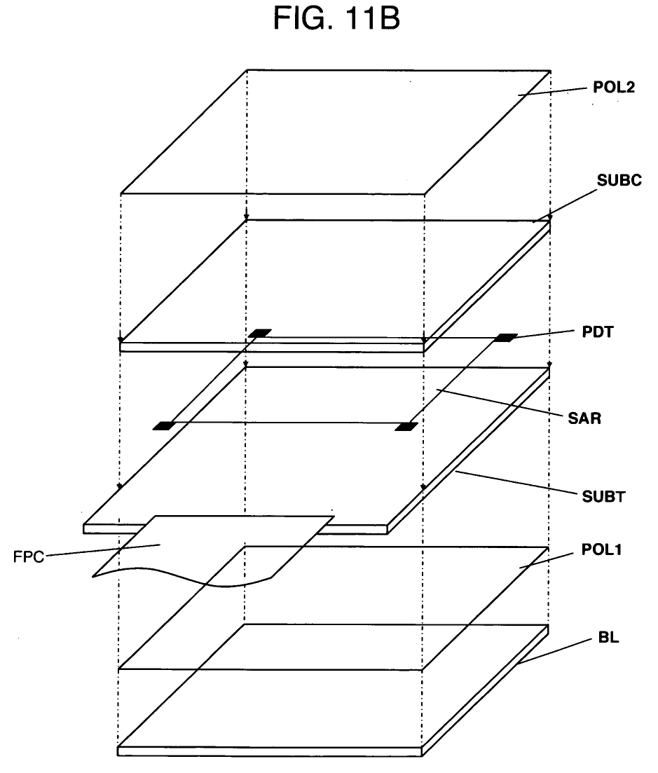

FIG. 11A is an exploded oblique view for explaining a second example of an image display device having a touch panel according to the present invention mounted thereon. Although this image display device is also a liquid crystal display device, it is suitable for a liquid crystal display device of the so-called transverse electric field scheme which does not have electrodes on the inner face of the counter substrate SUBC. In this example, a detection area SAR of a touch panel including a transparent conductive film pattern having a configuration according to any of the embodiments is provided on an outer face of the counter substrate SUBC and under a polarizer sheet POL2. The transparent conductive film included in the detection area SAR is protected from an external atmosphere by the polarizer sheet POL2.

FIG. 11B is an exploded oblique view for explaining a third example of an image display device having a touch panel according to the present invention mounted thereon. This image display device is obtained by applying a touch panel according to the present invention to a liquid crystal display device similar to that in the second example. In this example, a detection area SAR of a touch panel including a transparent conductive film pattern having a configuration according to any of the embodiments is provided on an inner face of the counter substrate SUBC.

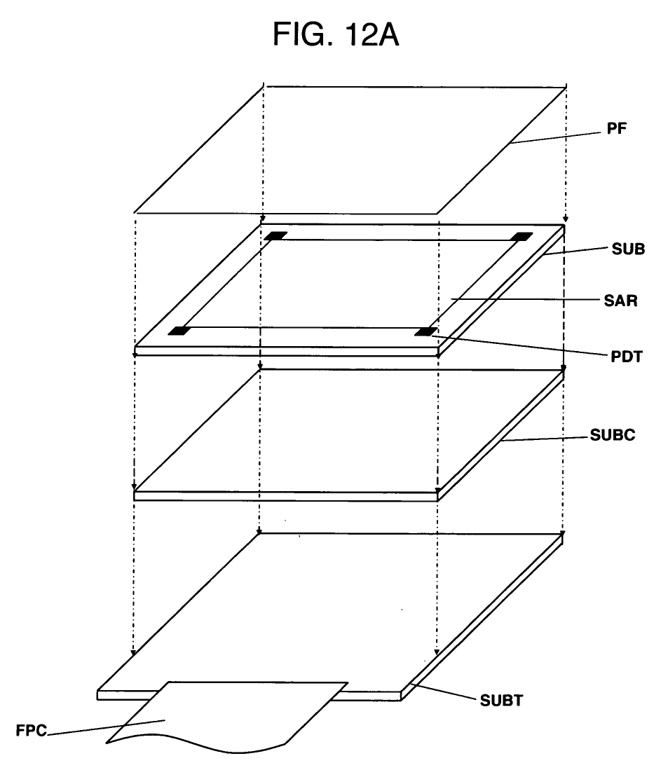

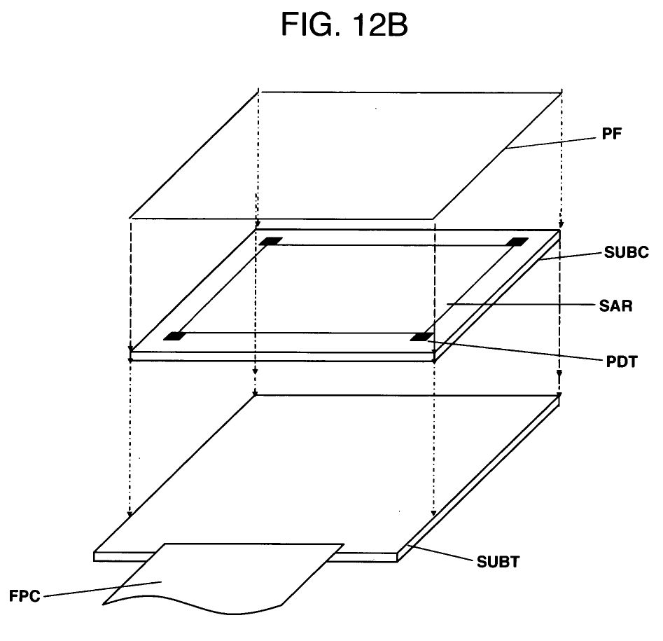

FIG. 12A is an exploded oblique view for explaining a fourth example of an image display device having a touch panel according to the present invention mounted thereon. This image display device is a top emission type organic EL display device. A main face of an active substrate SUBT having a plurality of pixels formed by arranging organic EL elements in a matrix form is sealed by a transparent counter substrate (the so-called seal can glass) SUBC. A touch panel formed of a transparent substrate SUB including a detection area SAR which has a transparent conductive film pattern having a configuration according to any of the embodiments is stacked on the counter substrate SUBC. The detection area SAR of the transparent conductive film pattern is covered by a transparent protection film PF.

FIG. 12B is an exploded oblique view for explaining a fifth example of an image display device having a touch panel according to the present invention mounted thereon. This image display device is also a top emission type organic EL display device. A main face of an active substrate SUBT having a plurality of pixels formed by arranging organic EL elements in a matrix form is sealed by a transparent counter substrate (the so-called seal can glass) SUBC. A detection area SAR of a touch panel which has a transparent conductive film pattern having a configuration according to any of the embodiments is formed directly on the counter substrate SUBC. The detection area SAR of the transparent conductive film pattern is covered by a transparent protection film PF.

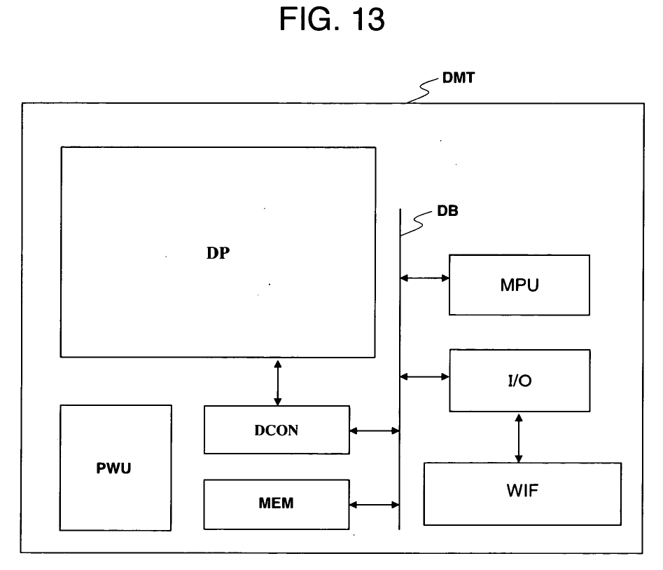

FIG. 13 is a diagram for explaining an example of a processing system of image data and touch coordinate data in a screen input type image display device according to the present invention. This image display device DMT has a TV receiving function. First, a wireless interface circuit WIF takes in image data compressed according to an instruction from external, and transfers the image data to a microprocessor MPU and a frame memory MEM via an input-output circuit I/O. Upon receiving an instruction operation from a user, the microprocessor MPU drives the whole image display terminal as occasion demands, and conducts compressed image data decoding, signal processing and information display.

The image data subjected to the signal processing can be temporarily stored in the frame memory MEM. If the microprocessor MPU issues a display instruction, image data from the frame memory MEM is input to a liquid crystal display DP via a display panel controller DCON according to the display instruction. The liquid crystal display DP displays the input image data in real time. At this time, the display panel controller DCON outputs a predetermined timing pulse required for displaying an image at the same time, and a voltage generation circuit PWU supplies a predetermined power supply voltage to the liquid crystal display DP.

A secondary battery is included separately in the image display device. The secondary battery supplies power for driving the whole image display terminal. Since this is not essence of the present invention, description thereof will be omitted. In addition, if the microprocessor MPU issues a touch panel input instruction, the display panel controller DCON drives a photo-detection circuit of the liquid crystal display DP, receives a photo-detection output from a control circuit, and outputs predetermined output data to the microprocessor MPU via a data bus DB according to the touch panel input instruction. The microprocessor MPU conducts new operation according to the output data.

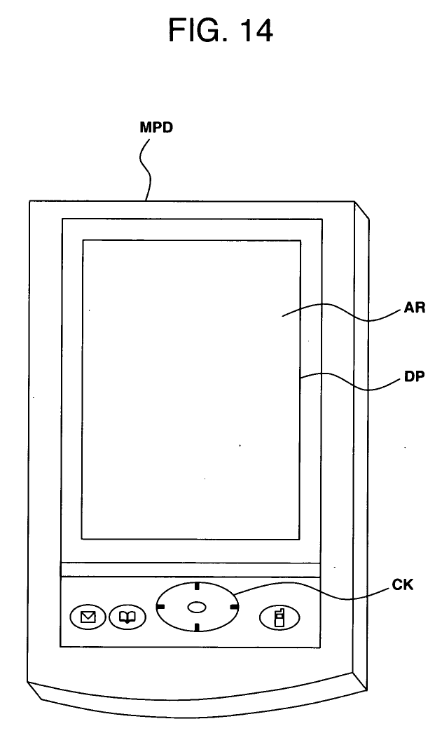

FIG. 14 is a front view for explaining a sixth example of an image display device having a touch panel according to the present invention mounted thereon. This image display device is a mobile electronic device MPD. This mobile electronic device MPD is equipped with a cross-shaped key CK besides an image display device DP having a touch panel according to the present invention. By touching display such as an icon on a display screen AR of the image display device with a finger, a dedicated touch panel module is not needed, but a user interface having a touch panel function for selection processing becomes possible.

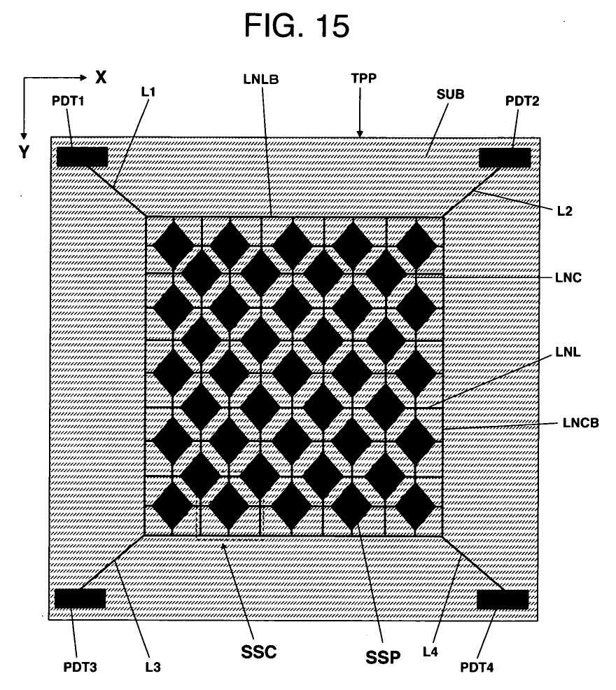

FIG. 15 is a plan view of a principal part of a touch panel for explaining a fifth embodiment of the present invention. The same reference characters as those in the foregoing diagrams denote like function parts. In the foregoing embodiments, the pad electrode SSP in the detection cell takes the shape of a rectangle. The fifth embodiment has the same configuration as any of the foregoing embodiments except that the pad electrode SSP in the detection cell takes the shape of a rhomb. As for the row connection electrodes LNL and the column connection electrodes LNC as well, the electrode width can be made wider as the location approaches the matrix center or the group center from the peripheral part.

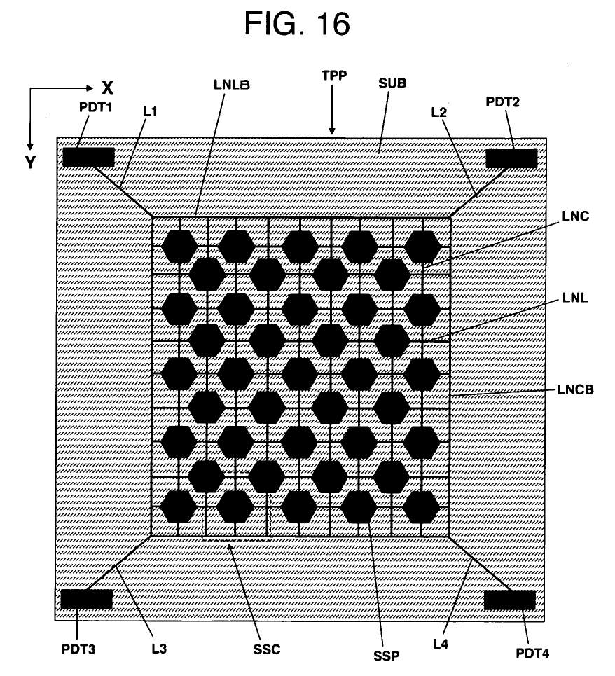

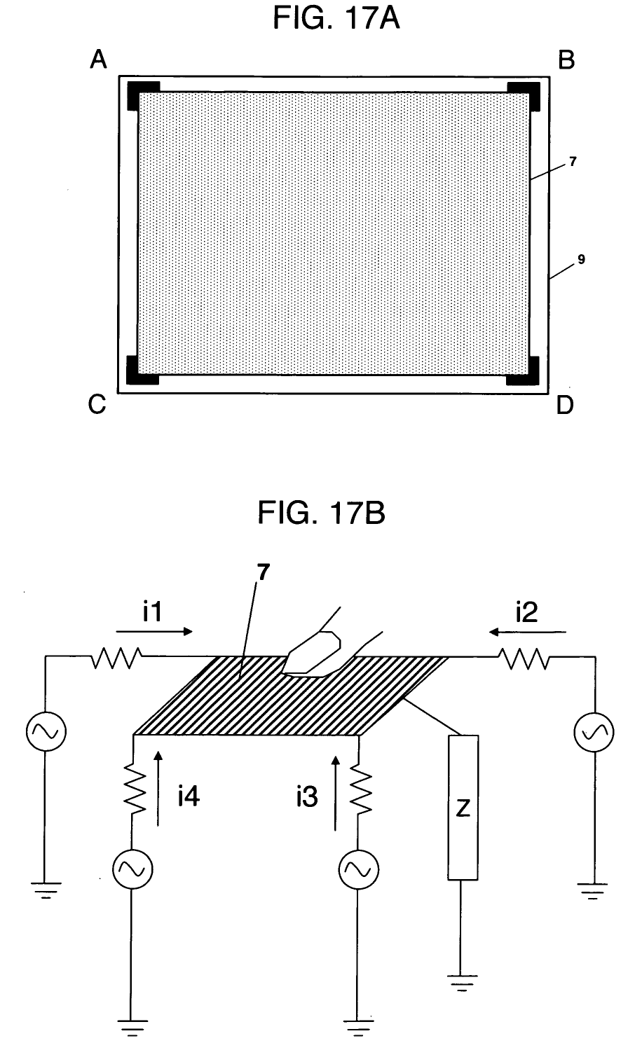

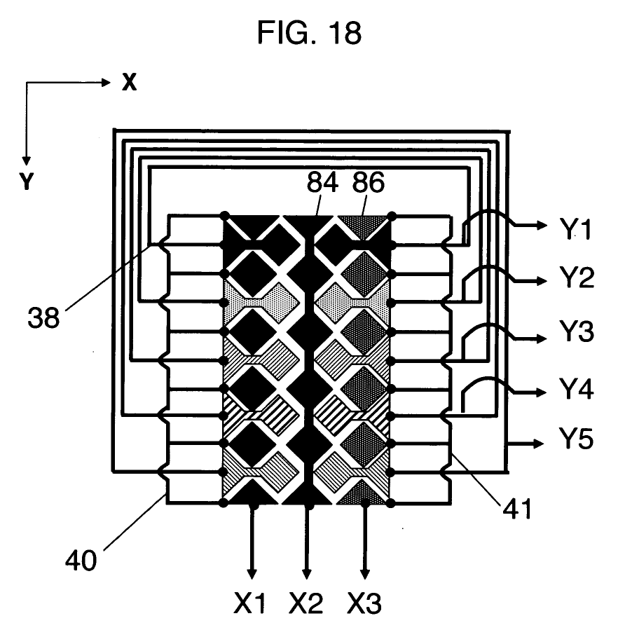

FIG. 16 is a plan view of a principal part of a touch panel for explaining a sixth embodiment of the present invention. The same reference characters as those in the foregoing diagrams denote like function parts. In the fifth embodiment, the pad electrode SSP in the detection cell takes the shape of a rhomb. The sixth embodiment has the same configuration as that in the fifth embodiment except that the pad electrode SSP in the detection cell takes the shape of a hexagon. As for the row connection electrodes LNL and the column connection electrodes LNC as well, the electrode width can be made wider as the location approaches the matrix center or the group center from the peripheral part.

The touch sensors according to the fifth embodiment and the sixth embodiment can also be applied to the foregoing image display devices.

It should be further understood by those skilled in the art that although the foregoing description has been made on embodiments of the invention, the invention is not limited thereto and various changes and modifications may be made without departing from the spirit of the invention and the scope of the appended claims.

1. A screen input type image display device including a touch sensor to detect two-dimensional coordinates of a touch position on a display screen,
wherein the touch sensor comprises:
a plurality of pad electrodes forming detection electrodes arranged in a two-dimensional matrix form on a substrate which forms the display screen of the image display device;
a transparent conductive film forming row connection electrodes and column connection electrodes to connect the pad electrodes included in the two-dimensional matrix to each other; and
coordinate detection terminals provided respectively in a plurality of places in a fringe of the transparent conductive film.

2. The screen input type image display device with touch sensor according to claim 1, wherein
the coordinate detection terminals are connected to the transparent conductive film via wires at ends including a plurality of corners of the transparent conductive film, and
two-dimensional coordinates of a touch position on the transparent conductive film are detected on the basis of currents which flow through the coordinate detection terminals in response to touch with the pad electrodes.

3. The screen input type image display device with touch sensor according to claim 2, comprising:
an alternating current generation circuit connected to the coordinate detection terminals via detection resistors; and
a signal processing circuit for generating coordinate data which represent the two-dimensional coordinates of the touch position on the basis of voltages generated across the detection resistors connected to a plurality of places which are preferably the corners by the currents.

4. The screen input type image display device with touch sensor according to claim 1, comprising:
row spine electrodes for connecting the column connection electrodes in a row connection; and
column spine electrodes for connecting the row connection electrodes in a column direction,
wherein
the coordinate detection terminals are connected to the row spine electrode and the column spine electrode located on outermost sides of the matrix by the wires.

5. The screen input type image display device with touch sensor according to claim 1, comprising:
an outside row spine electrode for connecting ends of the column connection electrodes in a row connection; and
an outside column spine electrode for connecting ends of the row connection electrodes in a column direction,
wherein
the outside row spine electrode and the outside column spine electrode comprise corner connection points at ends of them, and comprise the coordinate detection terminals at the corner connection points.

6. The screen input type image display device with touch sensor according to claim 1, wherein wiring widths of the column connection electrodes and the row connection electrodes become gradually wider as the location approaches the pad electrode side located inside the matrix.

7. The screen input type image display device with touch sensor according to claim 6, wherein the column connection electrode and the row connection electrode having widest wiring widths are located in one place on the inside of the matrix.

8. The screen input type image display device with touch sensor according to claim 7, wherein the column connection electrode and the row connection electrode having widest wiring widths are located in a center part on the inside of the matrix.

9. The screen input type image display device with touch sensor according to claim 7, wherein the column connection electrode and the row connection electrode having widest wiring widths are located in a part which is eccentric from a center part on the inside of the matrix.

10. The screen input type image display device with touch sensor according to claim 6, wherein the column connection electrode and the row connection electrode having widest wiring widths are located in a plurality of places on the inside of the matrix.

11. The screen input type image display device with touch sensor according to claim 1, wherein
a substrate forming the display screen of the image display device comprises an indispensable substrate included in the image display device and an additional substrate stacked on the indispensable substrate, and
the additional substrate comprises the transparent conductive film.

12. The screen input type image display device with touch sensor according to claim 1, wherein an indispensable substrate included in the image display device comprises a substrate forming the display screen of the image display device.
